(19) United States
(12) Patent Application Publication
(10) Pub. No.: US 2007/0039045 A1
(43) Pub. Date: Feb. 15, 2007

(54) Dual layered access control list

(75) Inventors: Tim McKee, Seattle, WA (US); Andrew Bybee, Duvall, WA (US); Walter Smith, Seattle, WA (US); David G. De Vorchick, Seattle, WA (US); Pedro Celis, Redmond, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/201,131

(22) Filed: Aug. 11, 2005

(51) Int. Cl. G06F 12/14

(52) U.S. Cl. 726/21

(57) ABSTRACT

A layer of abstraction for use by access control lists is provided for the process of creation and maintenance of user permissions on computer resources. First, a set of permissions can be associated with any number of computer resources. Also, computer resources can store references to any number of sets of permissions, and when use is requested, the sets of permissions are combined into a merged set that determines whether permission is granted. The extra level of abstraction results in an extra layer of information that allows individuals administering permissions to computer resources the ability to understand why they are set. The extra layer of information also results in a history of permissions for the computer resource since multiple references to sets of permissions can be stored.

### BACKGROUND

Computer file systems that exist today implement access control security on files and folders individually, thus allowing a user to be isolated from another user while accessing the same file system. For example, a first file may have security settings that permit only user A to access the first file. This security setting on the first file allows another user B to use the same file system without the concern that user B will wrongfully access the first file. The ability to isolate users on the same file system results in privacy of files. There is an array of permissions that can correspond to files and folders, such as read, write, and execute permissions. Also, if users desire, users can choose to change the security permissions on their files and folders to allow other users any of the array of permissions.

On the WINDOWS® brand operating system by Microsoft Corporation of Redmond, Wash., this security architecture is managed through an Access Control List (ACL). An ACL effectively states what rights various users have for a particular file or folder. These rights include, read, write, execute, modify, and security permissions, among others. For instance, a user might not be allowed to view a given file at all; or, the user may only be able to read the file; or, the user may be given rights to modify the file; or, the user may be given rights to change the ACL of the file, etc. There is a full spectrum of ACL permissions beyond those mentioned.

On the Windows® XP brand operating system, the default permission on a given item may be inherited from the permissions of the folder in which it was created. Additionally, when a folder is shared to another user, thus changing its permissions, the operating system may iterate through all the files beneath that folder and applies the change to the ACL for each file in the shared folder.

The problem with this model is that the ACL on any given item simply “is,” meaning permissions can be read, but no history or reasons for those permissions can be understood. The ACL states that user1 has access permission to the file or folder, but the reason for the grant of that permission is not provided in the ACL. Also, when removing permissions for a group of files, it is impossible to determine whether a permission for a particular file should remain because it was or would have been granted for a reason independent from that which concerns the group of files having the permission removed. If user1 has been given permission to access file1 because of reason1 and reason2, when reason1 becomes void and the access permission for user1 is removed, it is impossible to realize from the ACL that the permission should be retained because of reason2.

The Windows® XP brand operating system also allows for the creation of “groups,” which consist of a set of users and/or other groups. Once created, a group can be used within an ACL, which makes it easier to apply permissions to many users at once. Though a useful tool, the group utility does not provide a recorded reason for the permission. If a group has access to a file or folder, there is no way to determine why that permission was granted beyond the fact that the motivation is creating the group. The group utility also does not determine whether a given permission should be retained for an independent reason from the reason that it is being removed. If group1 has been given permission to access file1 because of reason1 and reason2, when reason1 becomes void and the access permission for group1 is removed, it is impossible to realize from the ACL that the permission should be retained because of reason2. In addition, groups do not themselves have any permission inherently associated with them.

### SUMMARY

The following presents a simplified, summary to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the present invention are directed to the creation and maintenance of access control lists (ACL) using an additional level of abstraction over the previous ACL model. According to one aspect an illustrative component of this new model may include a set of permissions, which lists users and/or groups and their respective permissions. Once created, the set of permissions can be associated with any number of one or more computer resources. Also, computer resources can store references to any number of one or more sets of permissions, and when use is requested, the sets of permissions are combined into a merged set that determines whether permission is granted for the particular use by the particular user.

The additional level of abstraction has several advantages over the previous ACL models. The extra layer of information can allow those individuals administering permissions to computer resources the ability to understand why the permissions have been stored. Since the sets of permissions store an identifier, the administrator can reference the identifier to understand why the permissions exist and why they are associated with certain computer resources. Also, the extra layer of information can result in a history of permissions for the computer resource. Since multiple references to sets of permissions can be associated with a single computer resource, references can be added and removed without affecting those that already exist.

Various features also introduce two mechanisms to apply references to sets of permissions to different computer resources. One mechanism is a “list” which functions similarly to a folder, except that a list is a separate data structure containing a user defined set of references to computer resources. Those resources whose references are contained in the list then inherit the list's references to sets of permissions. The other mechanism is an “autolist” which is similar to a list but instead of containing a user defined set of references to computer resources, an autolist stores a user defined set of rules including a scope and one or more match criteria to be applied across all computer resources within the scope to determine which resources are included within the autolist. Those resources determined to be associated with the autolist then inherit the autolist's references to sets of permissions.

### BRIEF DESCRIPTION OF THE DRAWINGS

A more complete understanding of aspects of the present invention may be acquired by referring to the following description in consideration of the accompanying drawings, in which like reference numbers indicate like features, and wherein:

FIG. 1 illustrates an operating environment in which one or more illustrative aspects of the invention may be performed.

FIG. 2 illustrates two sets of permissions that may be associated with computer resources according to an illustrative aspect described herein.

FIG. 3 illustrates how sets of permissions and explicit permissions can be associated with computer resources according to an illustrative aspect described herein.

FIG. 4A illustrates a list and its components according to an illustrative aspect described herein.

FIG. 4B illustrates the references to sets of permissions resulting from a list according to an illustrative aspect described herein.

FIG. 5A illustrates an autolist and its components according to an illustrative aspect described herein.

FIG. 5B illustrates the references to sets of permissions resulting from an autolist according to an illustrative aspect described herein.

FIG. 6 illustrates the computation of a merged set of permissions according to an illustrative aspect described herein.

FIG. 7 illustrates the decision flowchart for determining whether a request for use of a computer resource should be granted according to an illustrative aspect described herein.

FIG. 8 illustrates the extra layer of information from a set of permissions and how it can be associated with multiple computer resources according to an illustrative aspect described herein.

FIG. 9A illustrates two sets of permissions according to an illustrative aspect described herein.

FIG. 9B illustrates the resulting merged set of permissions when both sets of permissions are associated with the same computer resource according to an illustrative aspect described herein.

FIG. 9C illustrates how the extra layer of information results in a history so that the correct permissions are preserved when one set of permissions is removed according to an illustrative aspect described herein.

### DETAILED DESCRIPTION

In the following description of the illustrative aspects, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

Illustrative Operating Environment

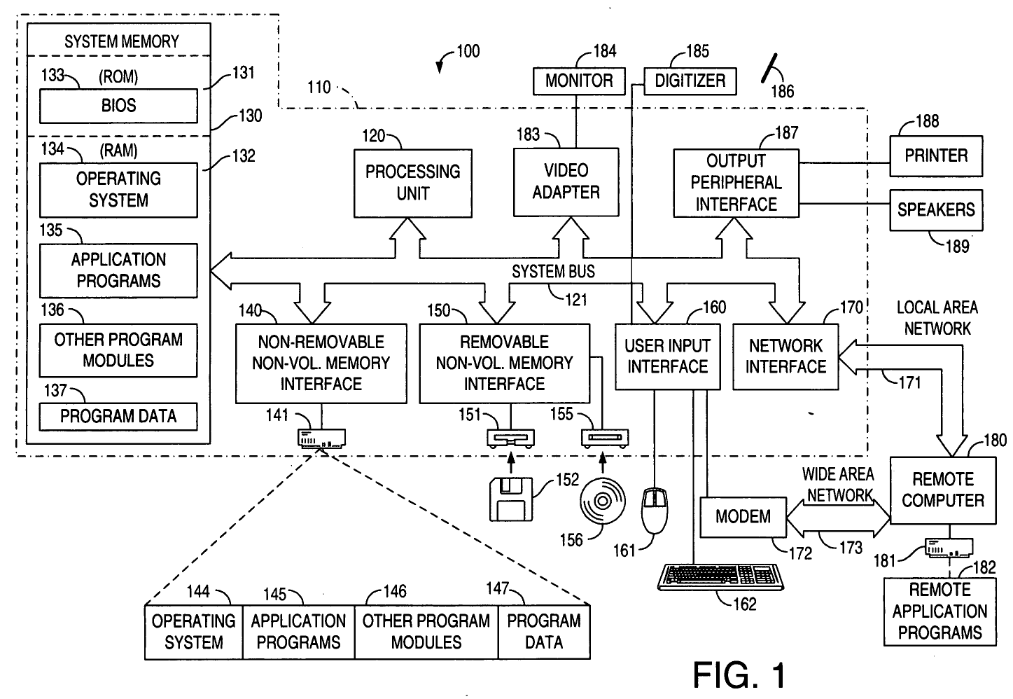

FIG. 1 illustrates an example of a suitable computing environment 100 in which the invention may be implemented. The computing environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers; server computers; portable and hand-held devices such as personal digital assistants (PDAs), tablet PCs or laptop PCs; multiprocessor systems; microprocessor-based systems; set top boxes; programmable consumer electronics; network PCs; minicomputers; mainframe computers; game consoles; distributed computing environments that include any of the above systems or devices; and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an illustrative system for implementing the invention includes a general purpose computing device in the form of a computer 110. Components of computer 110 may include, but are not limited to, a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Advanced Graphics Port (AGP) bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, DVD or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner, as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, DVD, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port, universal serial bus (USB), or IEEE 1394 serial bus (FireWire). At least one monitor 184 or other type of display device may also be connected to the system bus 121 via an interface, such as a video adapter 183. The video adapter 183 may support advanced 3D graphics capabilities, in addition to having its own specialized processor and memory. Computer 110 may also include a digitizer 185 to allow a user to provide input using a stylus input device 186. In addition to the monitor, computers may also include other peripheral output devices such as speakers 189 and printer 188, which may be connected through an output peripheral interface 187.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 may be connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 182 as residing on memory device 181. It will be appreciated that the network connections shown are exemplary and other means of establishing a communications link between the computers may be used.

One or more aspects of the invention may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

Illustrative Embodiments

Aspects of the present invention may be used to add a level of abstraction to security models and access control lists (ACL) by defining a set of permissions for a computer resource so that a history and reason for those permissions is retained, by naming each set of permissions, and applying the named set(s) of permissions to computer resources.

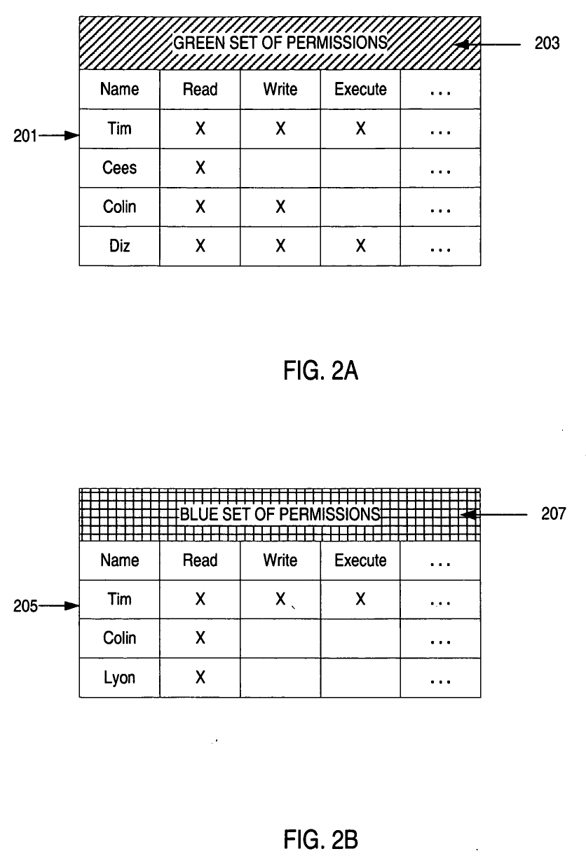

One or more aspects of the present invention store a set of one or more users and/or one or more groups and their associated permissions in a data structure operatively similar to that shown in FIGS. 2A and 2B. FIG. 2A illustrates a set of permissions 201 that, when applied to a computer resource (not shown), allow Tim and Diz to take any desired action, while Cees can only read from the computer resource, and Colin can read from and write to the computer resource. FIG. 2B illustrates another set of permissions 205 that, when applied to a computer resource (not shown), allow Tim to take any desired action, while Colin and Lyon can only read from the computer resource, and Jason and Kerem can read from and write to the computer resource. After each set of permissions 201 and 205 is created, the user or the system (such as through the operating system) may assign a reference or name 203, 207 to each set of permissions. In this example, the set of permissions 205 is referred to as blue 207, and the set of permissions 201 is referred to as green 203. Either or both references can be associated with any number of computer resources, which results in the application of the corresponding permissions onto those computer resources. As used herein, a computer resource can include but is not limited to files, folders, lists, autolists, email contact lists, emails, tasks, I/O ports, and any other identifiable computer resource.

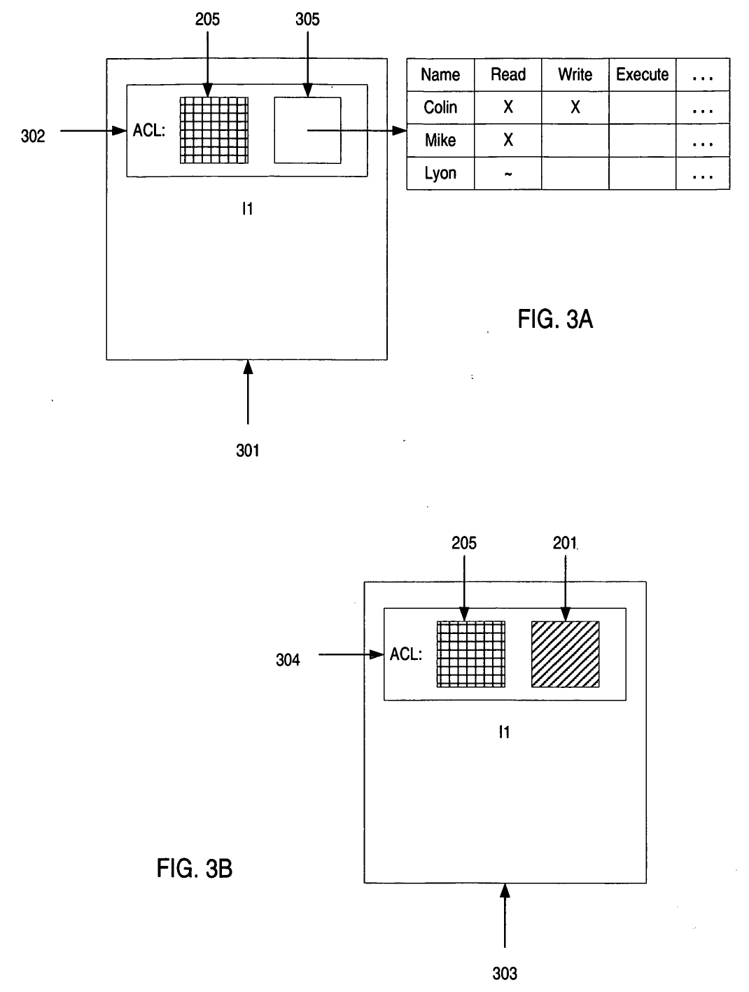

FIG. 3A illustrates a computer resource, here file I1 301. File I1 301 has a corresponding access control list 302. While ACL 302 is illustrated within computer resource 301, those of skill in the art will appreciate that ACL may alternatively be stored separately from the computer resources to which it corresponds. ACL 302 indicates that file I1 301 inherits any permissions defined by the blue set of permission 205, as well explicit permissions 305. As a result, item I1 301 has permissions that allow Tim to take any desired action; Colin, Lyon, and Mike to only read; Jason, Kerem, and John to read and write; and Lyon to be denied permission to read (where ‘not ’is represented as ‘˜’).

FIG. 3B illustrates a computer resource, here file 12 303. File I2 303 has a corresponding access control list 304. While ACL 304 is illustrated within computer resource 303, those of skill in the art will appreciate that ACL may alternatively be stored separately from the computer resources to which it corresponds. ACL 304 indicates that file I2 303 inherits any permissions defined by the blue set of permissions 205 as well as any permissions defined by the green set of permissions 201. Item I2 303 has permissions that allow Tim and Diz to take any desired action; Cees and Lyon to only read; and Colin, Jason, and Kerem to read and write. By using the additional level of abstraction, i.e., referencing in the ACL a name of a set of permissions, instead of listing the permissions themselves, a user can track from where the permissions originated, as further described below.

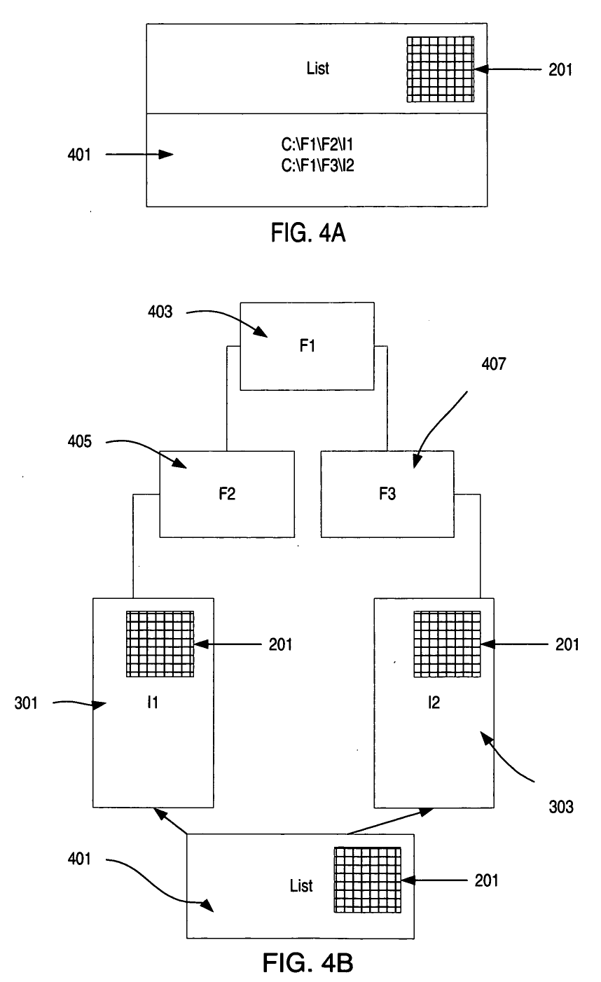

Aspects of the present invention provide an inheritance feature that takes at least two forms to apply references to sets of permissions to different computer resources. One mechanism is a “list” which functions similarly to a folder, except that a list is a separate data structure containing a user defined set of references 401 to computer resources as shown in FIG. 4A. Lists may further include optional annotations and have some prescribed order. FIG. 4A further shows that a set of permissions 205 may be associated with the list wherein all of the computer resources within the list 401 inherit a reference to the set of permissions 205 (in this example, the blue set of permissions) that is associated with the list. FIG. 4B illustrates the principle of inheritance, where the list has a reference to the set of permission 205 and all the computer resources associated with the list 401 subsequently store a reference to the set of permissions 205.

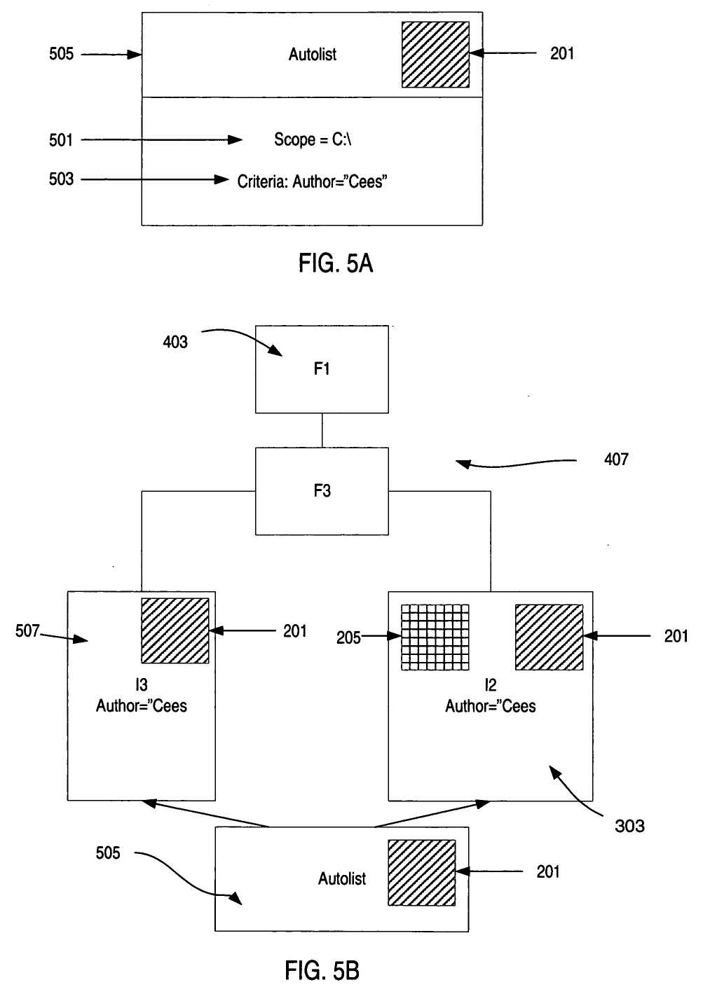

A second mechanism is an “autolist,” which is similar to a list but instead of containing a user defined set of references to computer resources, an autolist stores a user defined set of rules in the form of a scope 501 and one or more match criteria 503 to be applied across all computer resources within the scope to determine which resources are included within the autolist. Those resources determined to be associated with the autolist then inherit the autolist's references to sets of permissions 201. The scope 501 defines where the computer should look to evaluate computer resources, and the criteria 503 define the rules against which the computer resources' metadata are evaluated. One possible example of a rule is shown in FIG. 5A, where the autolist's rule has a scope that searches the entire C drive 501 and criteria applying to those computer resources whose author is Cees. All those computer resources that fall within the specified criteria and which are stored within the scope inherit all the references to sets of permissions associated with the autolist. The result of such an autolist is shown in FIG. 5B, where the computer resources I2 303 and I3 507 fall within the scope and criteria and thus inherit a reference to the set (or sets) of permissions associated with the autolist 201. Item I2 is illustrated as also referencing the blue set of permissions 205, as discussed in the previous example. The system also ensures that all items within the scope that do not match the criteria are not associated with the set(s) of permissions corresponding to the autolist. Further, the system may even go so far as to ensure that all items to which the system has access that do not match the criteria are not associated with the set(s) of permissions corresponding to the autolist.

Since autolists dynamically change, an illustrative feature may update the autolists so that the correct computer resources are associated with the permissions represented by the autolist. The autolist can be implemented to trigger the checking mechanism either by manual operation or automation. Manual operation may require a computer action such as, but not limited to, running a program or clicking a button that would start the operation. The automation implementation option may be as simple as running an update procedure at a set

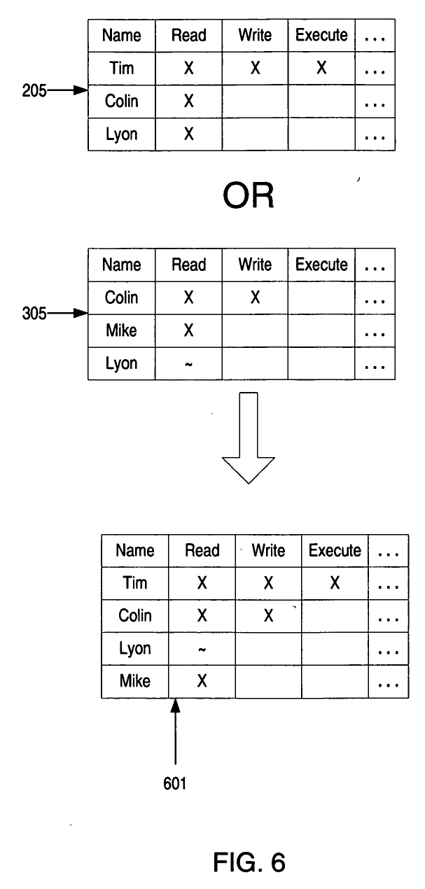

When there is more than one reference to different sets of permissions and/or explicit permissions for a single computer resource, then a merged set of permissions may be created to determine whether a request for use of that computer resource should be granted. For example, as illustrated above, item I1 201 references both the blue set of permissions 205 as well as additional explicit permissions 305 (FIG. 3A). Item I2 205 references both the blue 205 and green 201 sets of permissions (FIG. 3B). An illustrative merge process is shown in FIG. 6 where an OR operation may be applied across the different sets of permissions and explicit permissions associated with a given data object. In this example, FIG. 6 shows the merge for computer resource I1 301 with set of permissions 205 and explicit permissions 305. The result of the OR operation is shown in FIG. 6 item 601. Colin, who only had read access from the set of permissions 205, but had read and write access from the explicit permissions 305, receives read and write access as a result of the OR operation during the merge. Lyon's denials and permissions are combined so that Lyon only has one entry. This entry removes the read permission because it is overridden by the deny. Alternative embodiments may use multiple entries per user, each entry providing some of the permissions/denials from the combined permissions.

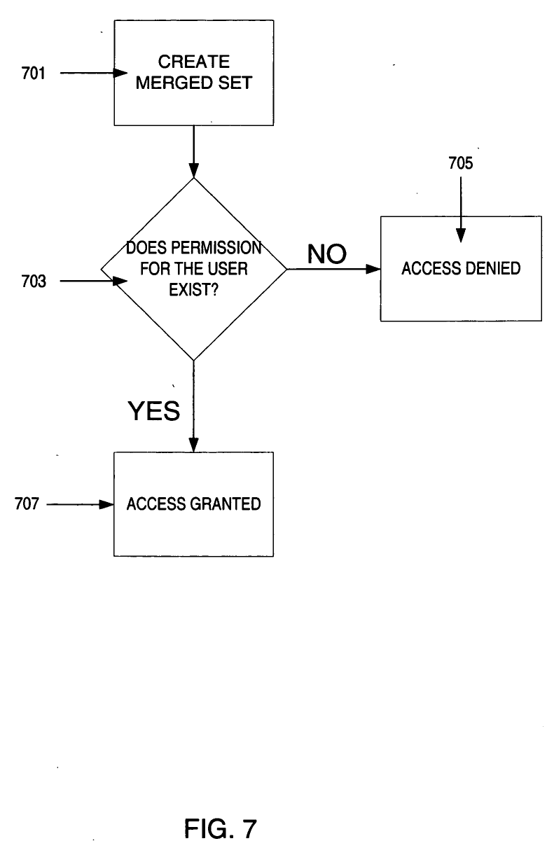

The merged set of permissions 601 can then be used to determine whether the request for use of the computer resource should be granted. A requested use may be granted to a user when the permission exists in the merged set. For example, using the information in 601 (FIG. 6) and following the flowchart in FIG. 7, if Lyon is requesting read access to I1 301, then after creating the merged list for I1 601 (step 701), the computer checks to see if there is a read permission associated with Lyon (step 703). If no such permission exists or there is a deny permission, then Lyon is denied read access (step 705). If such a permission does exist for Lyon, then Lyon is granted read access (step 707).

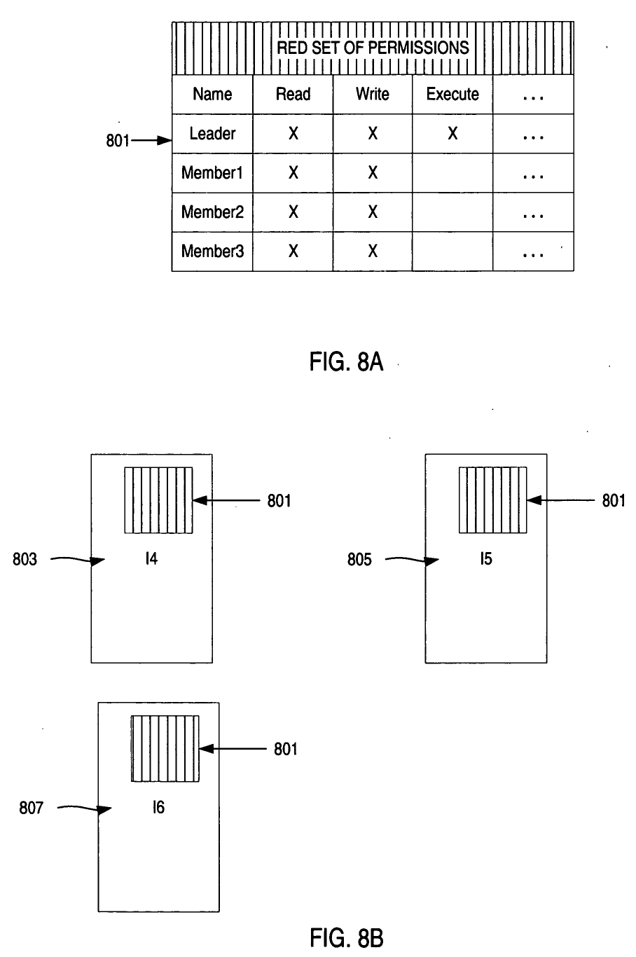

The layer of information created by illustrative features described herein allows for those individuals administering permissions to computer resources the ability to understand why the permissions are set. As shown in FIG. 8A, a company may create a team for a current project and have a set of permissions referred to as red 801 where the team leader gets full control and the other members get read and write access. As shown in FIG. 8B, after applying the red set of permissions 801 to different computer resources I4 803, I5 805, and I6 807, an administrator that is maintaining permissions can understand that it was created as a result of the project because it retains the red identifier 801. With this knowledge, the administrator can keep or remove the permissions from the computer resources accordingly. The group utility in the previous ACL models provided users associated with a group the exact same permissions, whereas according to aspects of the invention as described in the example above, different users can have different permissions within the same group.

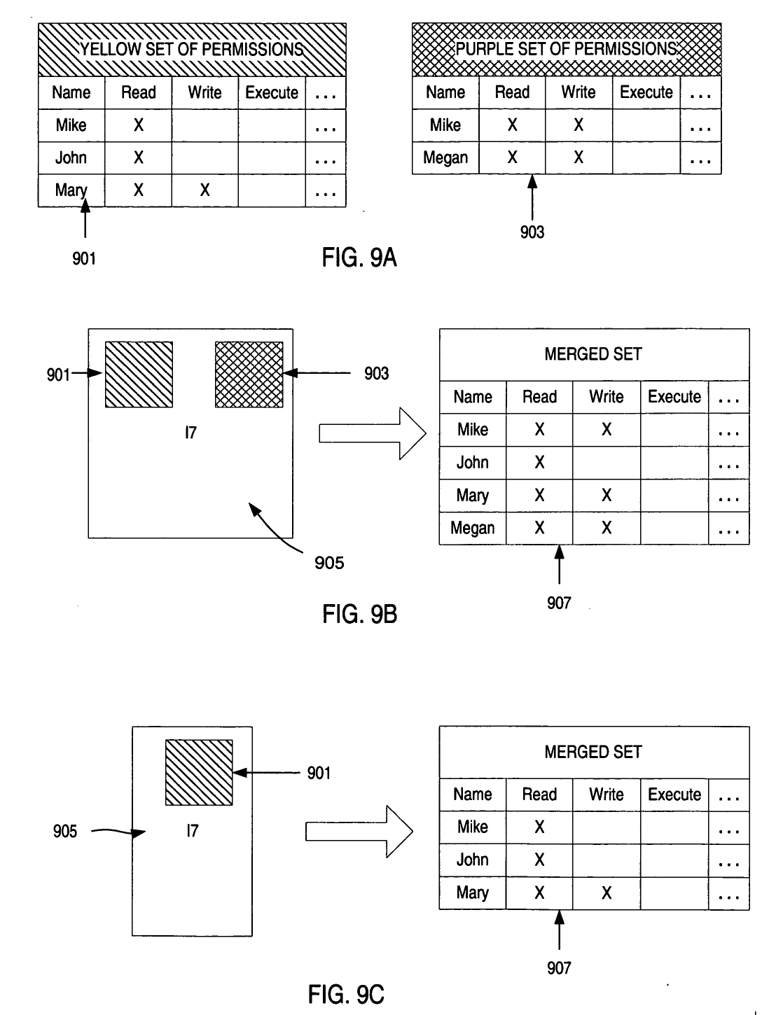

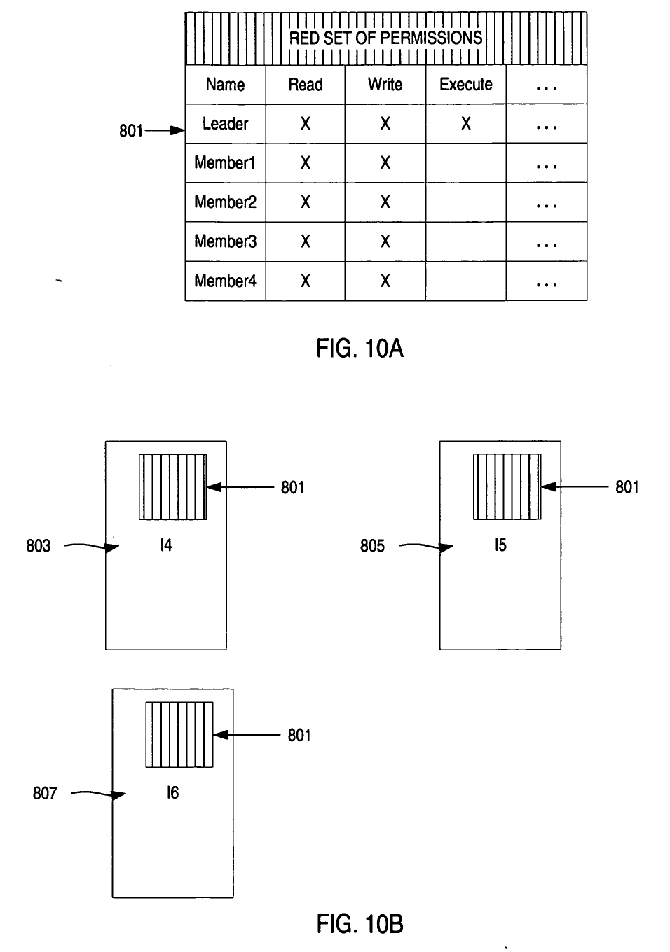

The extra layer of information created results in a history of permissions for the computer resource. As shown in FIG. 9A, Mike is given read access from a first set of permissions 901 referred to as yellow and is given read and write access from a second set of permissions 903 referred to as purple. When a request for use is made, the permissions from both sets 901, 903 are merged by the system giving Mike read and write access as shown in FIG. 9B because the file I7 905 stores a reference to the yellow set of permissions 901 along with a reference to the purple set of permissions 903. As shown in FIG. 9C, if the purple set of permissions 903 is removed for some reason, then the user will still maintain read access from the reference to the yellow set of permissions 901. In the previous ACL models, only a list of permissions is saved. The problem is that an administrator may remove the user's read and write access that would have been associated with the purple set of permissions 903. Even though the read access should remain since it also would have been granted because, it would have been associated with the yellow set of permissions 901, it is still removed because no reference to the yellow or purple set. of permission is saved, only the permissions themselves are saved. The historical information created according to certain aspects of the present invention in applying references to sets of permissions solves this problem.

The extra layer of information also allows permissions to be changed and disseminated to computer resources with ease. As shown in FIG. 10A, the red set of permissions 801 from FIG. 8 can be altered to add another member. Once altered, the red set of permissions 801 update all of the computer resources with which the red set of permissions 801 was associated. FIG. 10B shows that after the new member was added to the red set of permissions 801, then files I4 803, I5 805, and I6 807 now have the permissions associated with that new member. This update dissemination may be implemented with any update including by not limited by removal of a user, change of a current user's permissions, and adding of a user.

The extra level of abstraction of the ACL model provided according to certain aspects of the invention creates a layer of information that solves numerous problems that exist in the previous ACL model. The computer resources store multiple references to set of permissions and before granting access, combine the permissions into a merged set. This extra layer of abstraction allows those that are administering the ACL of the computer resources a way to remember why the ACL was applied to each particular computer resource. It also results in computer resources maintaining their permissions correctly since multiple references to sets of permissions can be stored, and thus, when one reference to a set of permissions is removed, the rest still persist resulting in a correct ACL. The extra layer also allows changes to permissions to be disseminated to computer resources with ease. The ACL model according to aspects of the invention also has features that make it easier to apply sets of permissions to different computer resources. Lists allow a user to apply one or more sets of permissions to computer resources that they associate with the list. Autolists allow a user to create a set of rules to apply to computer resource metadata, and those that match the rules then store the references to sets of permissions associated with the autolist. All these features are an improvement to the earlier technology of the previous ACL model.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive.

We claim:

1. A method of providing access control to a resource on a computer system, comprising the steps of:
(a) reading one or more references to a set of permissions corresponding to the computer resource,
(b) querying an access control database to obtain a set of permissions corresponding to each of the one or more references,
(c) merging the sets of permissions from step (b) to obtain a merged set of permissions for the computer resource,
(d) searching the merged set of permissions to identify whether an entity requesting a use of the computer resource has permission for such use.

2. The method of claim 1, wherein step (c) further comprises merging all the sets of permissions using an OR operation across the sets of permissions returned in step (b).

3. The method of claim 2, wherein each permission comprises a grant permission or a deny permission for a predetermined use of the computer resource, and wherein a deny permission overrides a corresponding grant permission.

4. The method of claim 1, wherein step (a) comprises reading the one or more references from an access control list (ACL).

5. The method of claim 1, wherein step (a) further comprises reading explicit permissions for the computer resource, and step (c) comprises merging the explicit permissions with the one or more sets of permissions from step (b).

6. The method of claim 1, wherein a first reference of the one or more references corresponds to a predetermined list.

7. The method of claim 1, wherein a first reference of the one or more references corresponds to a predetermined autolist.

8. The method of claim 1, wherein a first reference of the one or more references corresponds to a user selected reference.

9. One or more computer readable media storing computer executable instructions for performing the method of claim 1.

10. A method for setting security permissions for a computer resource:
(a) defining a first set of security permissions;
(b) defining a second set of security permissions;
(c) storing a first reference to the first set of security permissions and a second reference to the second set of security permissions in security data corresponding to the computer resource.

11. The method of claim 10, wherein the computer resource is defined by a list.

12. The method of claim 10, wherein the computer resource is defined by an autolist.

13. One or more computer readable media storing computer executable instructions for performing the method of claim 10.

14. One or more computer readable media having a data structure stored thereon, said data structure comprising:
(a) a first data field identifying a computer resource to which the data structure corresponds,
(b) a second data field comprising a first reference to a set of security permissions, and
(c) a third data field comprising a second reference to a set of security permissions.

15. The method of claim 14, wherein the data structure further comprises a fourth data field storing an explicit permission.
